(19) United States
(12) Patent Application Publication
(10) Pub. No.: US 2012/0169241 A1
(43) Pub. Date: Jul. 5, 2012

(54) ELECTRONIC DEVICE CAPABLE OF DETECTING ENVIRONMENT BRIGHTNESS AND METHOD THEREOF

(75) Inventors: CHUNG-JEN WANG, Tu-Cheng (TW); LI-SHENG SHU, Shenzhen (CN); BI-QING LUO, Shenzhen City, Guangdong Province (CN); TSUNG-JEN CHUANG, Tu-Cheng (TW); SHIH-FANG WONG, Tu-Cheng (TW)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/095,926

(22) Filed: Apr. 28, 2011

(30) Foreign Application Priority Data
Dec. 29, 2010 (CN) 201010612788.3

(51) Int. Cl. H05B 37/02; G09G 5/00

(52) U.S. Cl. 315/158; 345/207

(57) ABSTRACT

An electronic device capable of detecting environment brightness includes a camera and a processor. The camera includes a photo sensor. The photo sensor includes a number of photosensitive elements. The processor is to periodically turn on some or all of the photosensitive elements to direct the camera to capture an image, obtain R value, G value, and B value of each pixel of the captured image, and determine environment brightness according to the determined R value, G value, and B value of each pixel of the captured image. A related method is also provided.

### BACKGROUND

1. Technical Field

The present disclosure relates to electronic devices capable of detecting environment brightness and, particularly, to an electronic device capable of adjusting brightness of a backlight module of the electronic device according to the detected environment brightness and a method thereof.

2. Description of Related Art

A regular method for automatically adjusting brightness of a backlight module of an electronic device is that the electronic device employs a photosensitive sensor mounted on itself to sense environment brightness, and adjusts the brightness of the backlight module according to the sensed environment brightness. Employing the regular method, a photosensitive sensor should be mounted on the electronic device, which may increase cost of the electronic device.

### BRIEF DESCRIPTION OF THE DRAWINGS

The components of the drawings are not necessarily drawn to scale, the emphasis instead being placed upon clearly illustrating the principles of an electronic device capable of detecting environment brightness and a method thereof. Moreover, in the drawings, like reference numerals designate corresponding parts throughout several views.

FIG. 1 is a block diagram of an electronic device capable of detecting environment brightness, in accordance with an embodiment.

FIG. 2 is a flowchart of a method for detecting environment brightness, in accordance with an embodiment.

### DETAILED DESCRIPTION

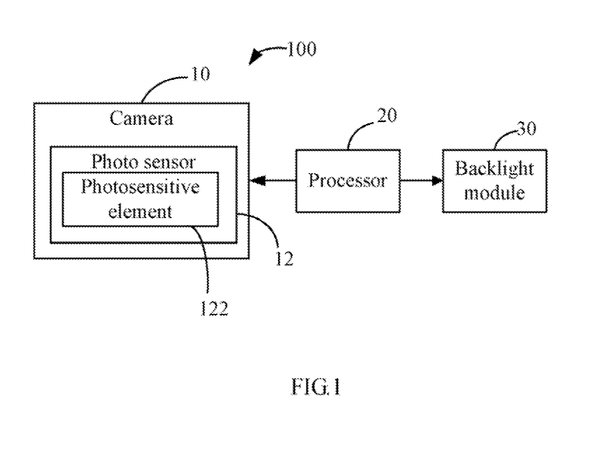

Referring to FIG. 1, an embodiment of an electronic device 100 capable of detecting environment brightness is illustrated. The electronic device 100 includes a camera 10 and a processor 20. The camera 10 includes a photo sensor 12 having a number of photosensitive elements 122. Each photosensitive element 122 corresponds to a pixel of a captured image. In this embodiment, the photosensitive element 122 is a photosensitive diode.

In this embodiment, the processor 20 periodically turns on a preset number of the photosensitive elements 122 to direct the camera 10 to capture an image. The preset number of the photosensitive elements 122 may be less than that of all of the photosensitive elements 122 or equal to that of all of the photosensitive elements 122. The processor 20 further determines R value, G value, and B value of each pixel of the captured image using known image processing technology, and determines environment brightness according to the determined R value, G value, and B value of each pixel. In this embodiment, the electronic device 100 employs the camera 10 to periodically capture an image, and determines environment brightness according to the captured image. Therefore, an additional photosensitive sensor is not needed, and cost of the electronic device 100 correspondingly decreases.

The electronic device 100 further includes a backlight module 30. The processor 20 adjusts brightness of the backlight module 30 according to the determined environment brightness. In one embodiment, the processor 20 adjusts brightness of the backlight module 30 according to comparison between the determined environment brightness and predetermined environment brightness. For example, if the processor 20 determines that the determined environment brightness is greater than the predetermined environment brightness, the processor 20 determines that environment is bright and thus decreases brightness of the backlight module 30.

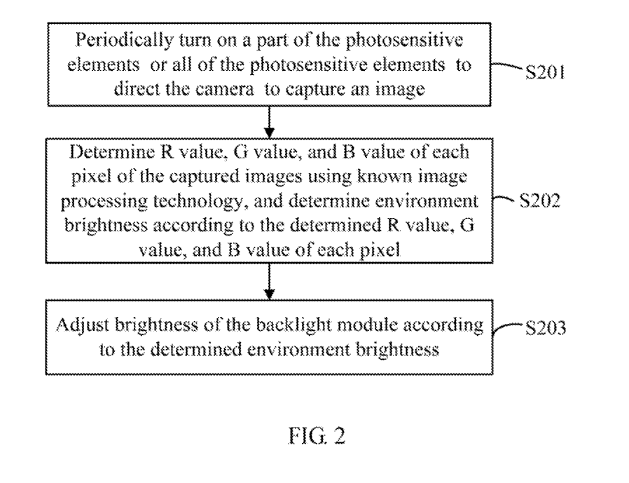

FIG. 2 is a flowchart of a method for detecting environment brightness in accordance with an embodiment.

In step S201, the processor 20 periodically turns on the preset number of the photosensitive elements 122 to direct the camera 10 to capture an image. The preset number of the photosensitive elements 122 may be less than that of all of the photosensitive elements 122 or equal to that of all of the photosensitive elements 122.

In step S202, the processor 20 determines R value, G value, and B value of each pixel of the captured images using known image processing technology, and determines environment brightness according to the determined R value, G value, and B value of each pixel.

In step S203, the processor 20 adjusts brightness of the backlight module 30 according to the determined environment brightness. In one embodiment, the processor 20 adjusts brightness of the backlight module 30 according to the comparison between the determined environment brightness and the predetermined environment brightness.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device capable of detecting environment brightness, the electronic device comprising:
a camera comprising a photo sensor, the photo sensor comprising a plurality of photosensitive elements; and
a processor to periodically turn on a preset number of the plurality of the photosensitive elements to capture an image, determine R value, G value, and B value of each pixel of the captured image, and determine environment brightness according to the determined R value, G value, and B value of each pixel of the captured image.

2. The electronic device as described in claim 1, further comprising a backlight module, wherein the processor is further to adjust brightness of the backlight module according to the determined environment brightness.

3. The electronic device as described in claim 2, wherein the processor is to adjust brightness of the backlight module according to comparison between the determined environment brightness and predetermined environment brightness.

4. The electronic device as described in claim 1, wherein the preset number of the plurality of the photosensitive elements is less than that of all of the plurality of photosensitive elements.

5. The electronic device as described in claim 1, wherein the preset number of the plurality of the photosensitive elements is equal to that of all of the plurality of photosensitive elements.

6. A method for detecting environment brightness applied in an electronic device, the electronic device comprising a camera, the camera comprising a photo sensor, the photo sensor comprising a plurality of photosensitive elements, the method comprising:
periodically turning on a preset number of the plurality of the photosensitive elements to direct the camera to capture an image;
determining R value, G value, and B value of each pixel of the captured image; and
determining environment brightness according to the determined R value, G value, and B value of each pixel of the captured image.

7. The method as described in claim 6, further comprising:
adjusting brightness of a backlight module of the electronic device according to the determined environment brightness.

8. The method as described in claim 7, wherein the step of adjusting brightness of a backlight module of the electronic device according to the determined environment brightness comprises: adjusting brightness of the backlight module according to comparison between the determined environment brightness and predetermined environment brightness.

9. The method as described in claim 6, wherein the preset number of the plurality of the photosensitive elements is less than that of all of the plurality of photosensitive elements.

10. The method as described in claim 6, wherein the preset number of the plurality of photosensitive elements is equal to that of all of the plurality of photosensitive elements.
